(19) United States
(12) Patent Application Publication
(10) Pub. No.: US 2025/0326666 A1
(43) Pub. Date: Oct. 23, 2025

(54) REGENERABLE ANODIZED POROUS ALUMINA DEVICE AND A METHOD OF FABRICATION THEREOF

(71) Applicant: Indian Institute of Technology Delhi, New Delhi (IN)

(72) Inventors: Bhaskar Mitra, New Delhi (IN); Madhusudan Singh, New Delhi (IN); Priya Vinayak, New Delhi (IN); Vikram Maharshi, New Delhi (IN); Ajay Agarwal, New Delhi (IN)

(21) Appl. No.: 18/870,695

(22) PCT Filed: Jun. 2, 2023
(86) PCT No.: PCT/IB2023/055689

§ 371 Date: Dec. 2, 2024

(30) Foreign Application Priority Data
Jun. 2, 2022 (IN) 202211031722

(51) Int. Cl. C02F 1/469; C02F 101/10; C02F 101/20; C25D 11/04

(52) U.S. Cl. CPC C02F 1/469; C25D 11/04; C02F 2101/103; C02F 2101/20

(57) ABSTRACT

The present disclosure relates to a device (100) for removal of contaminants from water, the device (100) includes a substrate (102), a metal layer (104) is deposited on the substrate (102) to form a conducting electrode. A thick layer of aluminium (Al) (106) is thermally deposited on the metal layer (104). The aluminum layer (106) is anodized so as to form an anodized porous alumina layer (108) having nanopores. The device, upon application of potential, allows the flow of water through the micropores to perform absorption of contaminants using the electrically conducting electrode covered with the anodized porous alumina layer facilitating removal of the contaminants from the water through ion concentration polarization and minimizing wastage of water.

### TECHNICAL FIELD

The present disclosure relates, in general, filtration device, and more specifically, relates to a regenerable anodized porous alumina device and method of removal of contaminants from water.

### BACKGROUND

Removing heavy metals from wastewaters is a challenging process that requires constant attention and monitoring, as heavy metals are major wastewater pollutants that are not biodegradable and thus accumulate in the ecosystem. Heavy metal discard in the environment has increased immensely in the last few decades, primarily due to industrialization. In addition, the persistent nature, toxicity and accumulation of heavy metal ions in the human body have become the driving force for searching for new and more efficient water treatment technologies to reduce the concentration of heavy metals in waters.

Given the toxicity of the heavy metal ions and their impact on human health, the environmental protection agency has set certain limits to control the concentration of these ions in drinking water and effluent discards. Henceforth, it is crucial to detect the concentration of these ions in water and remove them from the water effectively to protect the environment.

The popular commercial techniques involved in removing heavy metal ions from the water are electrodialysis, ion exchange, reverse osmosis, capacitive deionization, ultrafiltration, biological processes, and adsorption. Out of all the available techniques, adsorption is an effective technique for removing these ions from water. Metal oxides, charcoal, graphene, and nanoparticles have been used as adsorbents to remove heavy metal ions from water.

Therefore, it is desired to overcome the drawbacks, shortcomings, and limitations associated with existing solutions, and develop a compact, low-temperature, cost-effective, and efficient device with anodized porous alumina (APA) used as a pre-concentrator for removing heavy metal ions from water and reduces the water discard occurred in the reverse osmosis.

### OBJECTS OF THE PRESENT DISCLOSURE

An object of the present disclosure relates, in general, filtration device, and more specifically, relates to a regenerable anodized porous alumina device and method of removal of contaminants from water.

Another object of the present disclosure is to provide a device that is excellent in filtration accuracy and considerably improves the amount of filtration in less time.

Another object of the present disclosure is to provide a device that removes heavy metal ions from water and effluents.

Another object of the present disclosure is to provide a device that reduces the water discard that occurred in the reverse osmosis.

Yet another object of the present disclosure is to provide a compact, low-temperature, cost-effective, and efficient device.

### SUMMARY

The present disclosure relates, in general, filtration device, and more specifically, relates to a regenerable anodized porous alumina device and method of removal of contaminants from water. The main objective of the present disclosure is to overcome the drawback, limitations, and shortcomings of the existing filtering device and solution, by providing a device having the anodized porous alumina layer formed on conducting substrate for removing contaminants i.e., heavy metal ions from water and reduce the wastage of water discarded in the reverse osmosis process.

The present invention includes the device that includes a substrate, a metal layer is thermally deposited on the substrate to form a conducting electrode. A thick layer of aluminium (Al) is thermally deposited on the metal layer, where the aluminum layer is anodized so as to form an anodized porous alumina (APA) layer. The device, upon application of potential, allows the flow of water through the nanopores of the anodized porous alumina layer to perform absorption of contaminants facilitating removal of the contaminants from the water through ion concentration polarization and minimizing wastage of water. The adsorption of heavy metal ions from water samples can be achieved by using an electrically conducting electrode covered with anodized porous alumina (APA).

The anodized porous alumina layer increases the adsorption of the contaminants by order of magnitude. In addition, the adsorption is reversible and the adsorbed ions can be removed from the nanopores by applying a reverse pulse corresponding to the oxidation potential of the ion. The change in the current flow with the adsorption process signifies the removal of ions from water samples and thereby reducing the water discard that occurred in the reverse osmosis.

Further, the thickness of anodized porous alumina film (nanometer) and size of the overall device is in centimetre and can be placed inside any water treatment structure, thereby providing a compact, low-temperature, cost-effective, and efficient device to improve the amount of filtration in less time.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The following drawings form part of the present specification and are included to further illustrate aspects of the present disclosure. The disclosure may be better understood by reference to the drawings in combination with the detailed description of the specific embodiments presented herein.

FIG. 1A illustrates exemplary views of the proposed device, in accordance with an embodiment of the present disclosure.

FIG. 1B illustrates exemplary views of the fabrication process flow of the proposed device, in accordance with an embodiment of the present disclosure.

FIG. 1C illustrates elemental mapping of copper deposited on anodized porous alumina (APA), in accordance with an embodiment of the present disclosure.

FIG. 1D illustrates chronoamperometry data of copper deposition over the APA for varying concentrations, in accordance with an embodiment of the present disclosure.

FIG. 1E illustrates elemental mapping of cadmium deposited on the APA, in accordance with an embodiment of the present disclosure.

FIG. 1F illustrates chronoamperometry data of cadmium deposition over the APA for varying concentrations, in accordance with an embodiment of the present disclosure.

FIG. 2A illustrates cross-sectional view of SEM image of APA device, in accordance with an embodiment of the present disclosure.

FIG. 2B illustrates cross-sectional view of FESEM image of APA device, in accordance with an embodiment of the present disclosure.

FIG. 3 illustrates a flow chart of the method of removal of contaminants from water, in accordance with an embodiment of the present disclosure.

FIG. 4A to 4C illustrates a graphical view of linear sweep voltammetry data, in accordance with an embodiment of the present disclosure.

FIG. 5A to 5B illustrates a graphical view of linear sweep voltammetry data for removal of copper ions from water, in accordance with an embodiment of the present disclosure.

FIG. 6A to 6B illustrates a graphical view of chronoamperometry data for removal of arsenic ions, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The proposed device disclosed in the present disclosure overcomes the drawbacks, shortcomings, and limitations associated with the conventional device by providing a device having the anodized porous alumina layer formed on conducting substrate for removing contaminants i.e., heavy metal ions from water and reducing the water discard occurred in the reverse osmosis. The proposed device can include a substrate, a metal layer for conduction is formed upon the substrate by depositing metals on the substrate. A thick layer of aluminium (Al) is thermally deposited on the metal layer. The device is fabricated by anodizing the aluminum layer deposited over the conducting substrate. The aluminum layer is anodized so as to convert aluminium layer to an anodized porous layer. The anodized porous alumina layer having nanopores whose degree of ordering, porosity and pore size fall within predetermined ranges. The present disclosure can be described in enabling detail in the following examples, which may represent more than one embodiment of the present disclosure.

The term “reverse osmosis” as used herein refers to water treatment process that removes contaminants from water by using pressure to force water molecules through a filter unit. During this process, the contaminants are filtered out and flushed away, leaving clean water.

The term “ion concentration polarization (ICP)” is an electrochemical transport phenomenon that occurs when ion current is passed through an ion-selective membrane or nanoporous junction.

In an aspect, the present disclosure relates to device for removal of contaminants from water. The device includes the substrate. The substrate can be selected from a group comprising silicon, borosilicate glass, PET sheet, PDMS or any nonreactive flexible substrate and any combination thereof. The metal layer is deposited on the substrate to form the conducting electrode. The metal is selected from platinum (Pt) and gold (Au) and any combination thereof. The thick layer of aluminium (Al) is thermally deposited on the metal layer and the aluminum layer is anodized so as to form an anodized porous alumina layer having nanopores. The water flow through the micropores, upon application of potential to the device, to perform absorption of contaminants using the electrically conducting electrode covered with the anodized porous alumina layer facilitating removal of the contaminants from the water through ion concentration polarization and minimizing wastage of water. The contaminants are heavy metal ions selected from a group comprising copper, ion (Cu²⁺), Cadmium ion (Cd²⁺), lead ion (Pb²⁺), zinc ion (Zn²⁺), arsenic (As³⁺) and any combination thereof.

According to an embodiment, the anodized porous alumina layer having nanopores whose degree of porosity and pore size fall within predetermined ranges. The anodized porous alumina layer increases the adsorption of the contaminants by order of magnitude. The anodization is performed over thermally deposited aluminum layer, where electrochemical process is used to analyse the adsorption of ions over the surface of the anodized porous alumina layer.

The advantages achieved by the device of the present disclosure can be clear from the embodiments provided herein. The anodized porous alumina layer increases the adsorption of the contaminants by order of magnitude and removes contaminants such as heavy metal ions from water and effluents and reduces the wastage of water occurred in the reverse osmosis. For example, the wastage of water can be removed in millilitres and the clean water can flow out in litres.

Further, the device is compact and cost-effective that is excellent in heavy metal removal accuracy and considerably improves the clearance in less time. The description of terms and features related to the present disclosure shall be clear from the embodiments that are illustrated and described; however, the invention is not limited to these embodiments only. Numerous modifications, changes, variations, substitutions, and equivalents of the embodiments are possible within the scope of the present disclosure. Additionally, the invention can include other embodiments that are within the scope of the claims but are not described in detail with respect to the following description.

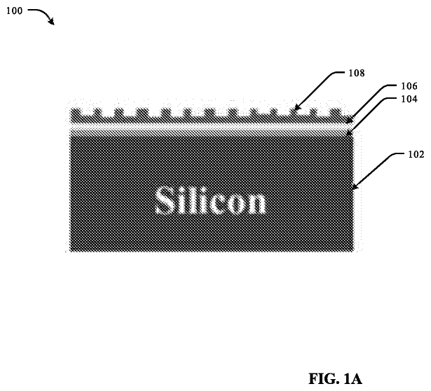

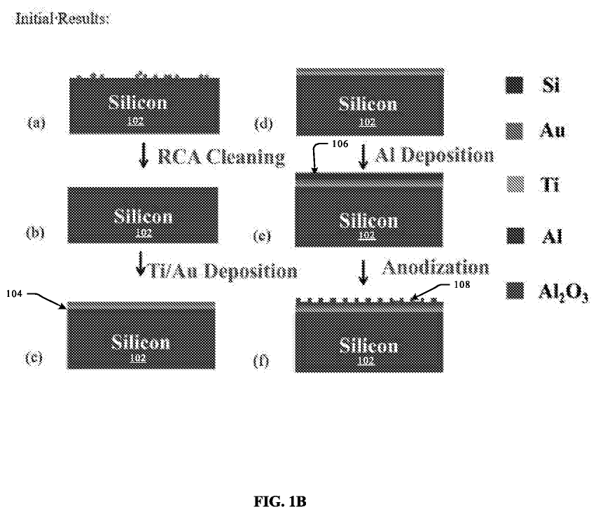

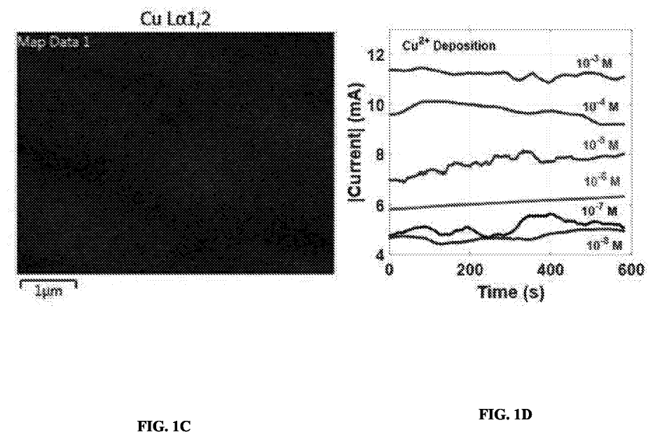

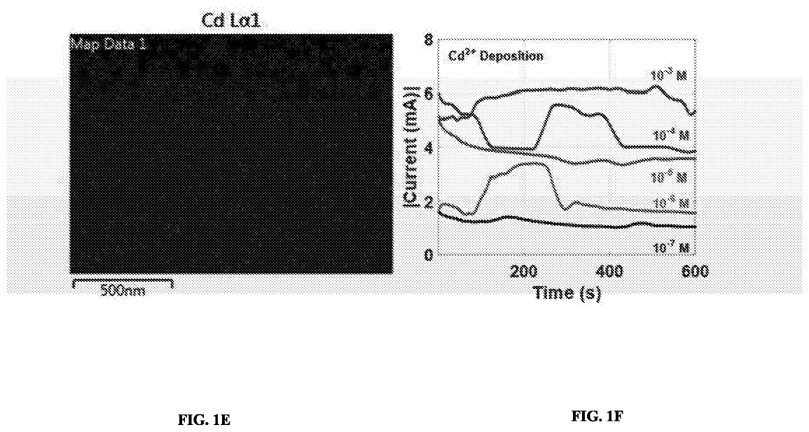

FIG. 1A illustrates exemplary views of the proposed device, in accordance with an embodiment of the present disclosure.

Referring to FIG. 1A, an anodized porous alumina device 100 (also referred to as a device 100, herein) configured for purifying, storing and dispensing water suitable for domestic purposes, which is received from a supply of water containing contaminants. The contaminants can include salts, heavy metals ions and biological contaminants from source water. The battery-operated device 100 having porous alumina adapted for separating purified water from the supply water. The proposed device 100 is configured to perform electrochemical extraction of contaminants using porous alumina. The proposed device 100 can include a substrate 102, a metal layer 104, an aluminum layer 106 and an anodized porous alumina layer 108. The proposed device 100 can be used alone or in combination with reverse osmosis to remove heavy metal ions from the water and effluent through ion concentration polarization even in the low ppm concentration range. The water discarded occurred in reverse osmosis can also be reduced by the use of the device 100.

The proposed device 100, as presented in the example, can be configured for adsorption of heavy metal ions from water and effluents using an electrically conducting electrode covered with anodized porous alumina (APA). As can be appreciated, the present disclosure may not be limited to this configuration but may be extended to other configurations. The use of an insulating porous alumina film above the conducting electrode increases the adsorption of heavy metal ions by order of magnitude. The device 100 can increase the sensitivity of ionic sensors and in a system or structure for removing these heavy metal ions from water and effluents. In an exemplary embodiment, the thickness of the device 100 can be between 100 micrometer to few centimeter and can be placed inside the structure e.g., water purifier for purifying, storing and dispensing water suitable for domestic purposes as well as effluent storing units. Further, the size of the device 100 can be modified based on the desired applications, for example, domestic, industrial applications and the like.

The proposed device 100 can include substrate holding substrate 102, which can be placed in the heavy metal clearance chamber. In an exemplary embodiment, substrate 102 as presented in the example can be silicon, PET sheet, PDMS or any non reactive material having a high strength is preferable. The metal layer 104 for conduction is formed upon the substrate102 by depositing nobel metals on the substrate 102. In another exemplary embodiment, the metal as presented in the example can be selected from titanium (Ti) or chrome (Cr)/gold (Au) or platinum (Pt) and any combination thereof. The thick layer of aluminium (Al) 106 is thermally deposited on the metal layer 104. The device 100 is fabricated by anodizing the aluminum layer 106 deposited over the conducting substrate. The aluminum layer 106 is anodized so as to convert aluminum layer 106 to an anodized porous alumina layer 108 or aluminum oxide film (Al₂O₃). The anodized porous alumina layer 108 having nanopores whose degree of ordering, porosity and pore size fall within predetermined ranges. The predetermined range of the pore size can be, for example, in the range between 30 nm to 100 nm and the depth can be 100 nm to 1000 nm. The device 100, upon application of potential, is adapted to allow the flow of water through the micropores of the anodized porous alumina layer 108 and perform absorption of contaminants using the electrically conducting electrode covered with the anodized porous alumina and removes contaminants from the water through ion concentration polarization.

In an implementation, the device 100 can be mounted in the water purifier and the water to be filtered is received from the source and across the surface of the proposed device having anodized porous alumina layer 108 adapted to allow the flow of water through it and reduce contaminants i.e., heavy metal ions in the received water and minimizes the wastage of water. The heavy metal ions are adsorbed over the metal-APA sandwich by applying a negative potential to the device 100 for a certain amount of time. The device's negative potential cause positive cations to accumulate due to ion concentration polarization. Further, when the applied voltage is greater than the electrochemical reduction potential of the ion, the ions get deposited on the metal surface. This adsorption is reversible and can be reversed by applying a positive pulse to remove the ions from the pores. The change in the current flow with the adsorption process signifies the removal of ions from water samples. The proposed device 100 removes contaminants i.e., heavy metal ions from water and reduce the water wastage. For example, the wastage of water can be in millilitres and the clean water can flow out in litres.

### Fabrication Process and Experimental Results

FIG. 1B illustrates exemplary views of the fabrication process flow of the proposed device, in accordance with an embodiment of the present disclosure. The device 100 is fabricated by anodizing the aluminum layer 106 deposited over the conducting substrate 102. The proposed device 100 can be fabricated by using the solid or flexible substrate 102 selected from a group comprising silicon, borosilicate glass, PET, PDMS and the like. The Radio Corporation of America (RCA) cleaning method is used to clean the contaminant from the substrate 102. RCA cleaning is used to remove organic and ionic contaminants residues from silicon wafers. In the process, it oxidizes the silicon and leaves a thin oxide on the surface of the wafer, which can be removed if a pure silicon surface is desired.

In the next step, the metal layer 104 is deposited on the substrate 102 to form conduction substrate 102. The metal layer 104 is selected from titanium (Ti)/chrome (cr) and gold (Au) or platinum (Pt) and any combination thereof. Subsequently, the thick layer of aluminium (Al) 106 is deposited on the metal layer by the thermal oxidation process.

Further, aluminum layer 106 is anodized so as to form aluminum oxide (Al₂O₃) film from the aluminum layer 106. The anodization of the surface of aluminum layer 106 is prepared by anodizing in solutions having different concentrations of acids contained in the electrolytic solution and supplying potential. The aluminum layer 106 is anodized in a bath of oxalic acid at a voltage within a predefined voltage range, thereby forming porous alumina having multiple pores. After application of potential the aluminium gets converted into anodized porous alumina i.e., aluminium gets converted into aluminum oxide (Al₂O₃).

The fabrication of the anodized porous alumina-based adsorption device 100 is adapted to remove heavy metal ions. The anodization can be performed using two step process over thermally deposited aluminum, and electrochemical techniques or chronoamperometry were used to analyse the adsorption of ions over the surface of APA. The term chronoamperometry is an electrochemical technique in which the potential of the working electrode is stepped and the resulting current from faradaic processes occurring at the electrode (caused by the potential step) is monitored as a function of time.

The device 100 made this way is efficient for the adsorption or removal of heavy metal ions such as copper, ion (Cu²⁺), Cadmium ion (Cd²⁺), lead ion (Pb²⁺), zinc ion (Zn²⁺), arsenic ions (As³⁺) as among many other ions in the concentration range of 10⁻³ M to 10⁻⁹ M.

The ICP-MS data for arsenic samples before and after adsorption over APA electrode shown in table 1 below.

TABLE 1
ICP-MS data for arsenic samples before
and after adsorption over APA electrode

| Before adsorption | After adsorption |
|---|---|
| arsenic conc. (ppm) | arsenic conc. (ppm) |
| 0.01 | 0.014 |
| 0.1 | 0.028 |
| 1 | 0.531 |
| 10 | 3.846 |
| 100 | 42.835 |
| 1000 | 408.338 |

However, these are just exemplary values, and that the actual values can be a wide range, and the values included here are just for illustrative purposes other values and integer multiples are possible as well.

The absolute value of current changes linearly with the concentration of heavy metal ions in water samples and the calibration plot between current and heavy metal ion concentration is used to detect heavy metal ions in the solution. FIG. 1C depicts elemental mapping of copper deposited on the surface of the anodized porous alumina and FIG. 1D shows chronoamperometry data of copper deposition over the anodized porous alumina for varying concentrations.

Similarly, FIG. 1E depicts elemental mapping of cadmium deposited on the surface of the anodized porous alumina and FIG. 1F shows chronoamperometry data of cadmium deposition over the surface of the anodized porous alumina for varying concentrations.

Thus, the present invention overcomes the drawbacks, shortcomings, and limitations associated with existing solutions, and provides a compact, cost-effective, and efficient device that is excellent in filtration accuracy and considerably improves the amount of filtration in less time. The proposed device removes heavy metal ions from water and effluents and reduces the water discard occurred in the reverse osmosis. Further, the device can be biodegradable that is capable of being decomposed by other living organisms and thereby avoiding pollution.

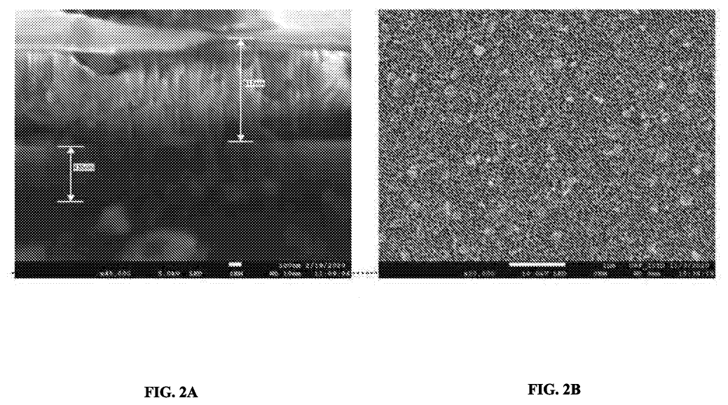

FIG. 2A illustrates cross-sectional view of scanning electron microscopy (SEM) image, as shown in FIG. 2A, 817 nm aluminium (Al) is deposited on the metal layer 104. The aluminum layer 106 is anodized thereby forming porous alumina having multiple pores.

FIG. 2B shows field emission scanning electron microscope (FE-SEM) image of APA device, in accordance with an embodiment of the present disclosure. The porous alumina film is depicted in FIG. 2B, where the porous alumina is formed after anodization having numerous pores having a uniform shape. The use of an insulating porous alumina increases the adsorption of metal ions by order of magnitude. It can increase the sensitivity of ionic sensors and in a system for removing these ions from water.

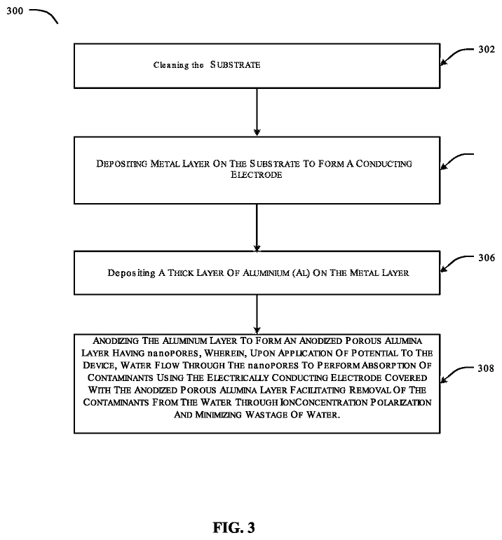

FIG. 3 illustrates a flow chart of the method of removal of contaminants from water, in accordance with an embodiment of the present disclosure.

Referring to FIG. 3, the method 300 include a block 302, the device 100 that can be fabricated by using the substrate 102 selected from the group comprising silicon, borosilicate glass, PET sheet, PDMS and the like. The RCA cleaning method is used to clean the contaminant from the substrate 102. RCA cleaning is used to remove organic and ionic contaminants residues from silicon wafers. In the process, it oxidizes the silicon and leaves a thin oxide on the surface of the wafer, which can be removed if a pure silicon surface is desired.

At block 304, the metal layer 104 deposited on the substrate 102 to form conduction substrate. The metal layer 104 selected from titanium (Ti)/chrome (Cr) and gold (Au)/Platinum (Pt) and any combination thereof. At block 306, the thick layer of aluminium (Al) 106 is deposited on the metal layer by thermal oxidation process, where the thermal oxidation process is a way to produce a thin layer of oxide on the surface of the wafer.

Further, at block 308, the aluminum layer 106 is anodized so as to form an aluminum oxide (Al₂O₃) film from the aluminum layer 106. The anodization of aluminum layer 106 is prepared by anodizing in solutions having different concentrations of acids contained in the electrolytic solution and supplying potential. After application of potential the aluminium gets converted into anodized porous alumina i.e., aluminium gets converted into aluminum oxide (Al₂O₃).

The aluminum layer 106 is anodized to form the anodized porous alumina layer 108 having micropores. The device, upon application of potential, allows the flow of water through the micropores to perform absorption of contaminants using the electrically conducting electrode covered with the anodized porous alumina layer facilitating removal of the contaminants from the water through ion concentration polarization and minimizing wastage of water.

### Experimental Results

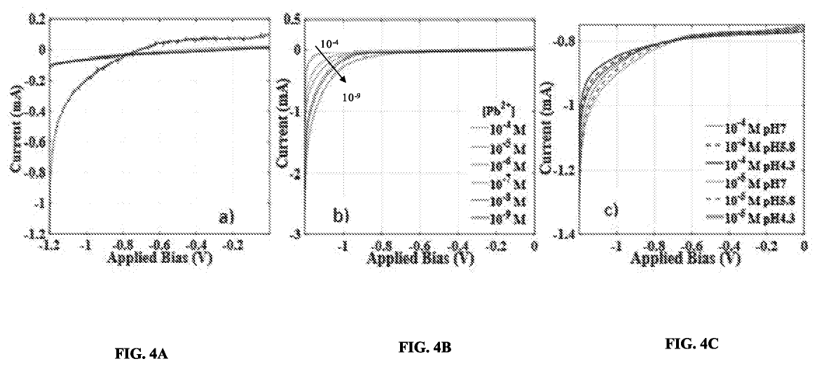

FIG. 4A to 4C illustrates a graphical view of linear sweep voltammetry (LSV) data, in accordance with an embodiment of the present disclosure. FIG. 4A depicts linear sweep voltammetry data for only gold electrodes for different concentration of lead ions in water samples FIG. 4B depicts linear sweep voltammetry data for anodized porous alumina for different concentrations of lead ions and FIG. 4C depicts linear sweep voltammetry data for anodized porous alumina at different pH values for 104 and 105 Molar lead ions solution. The LSV data demonstrate the ion concentration polarization behavior of device for the adsorption of heavy metal ions and then creates a depletion region, which do not have any ions and hence clearing the ions from the water samples. Table 2 shoes the decrease in concentration of lead ions on repeated use of device.

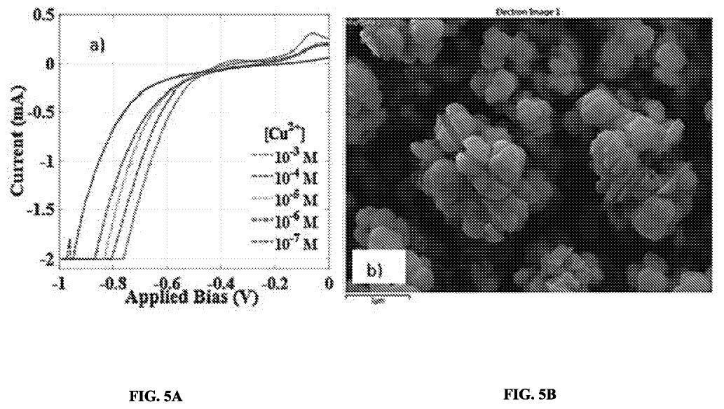

FIG. 5A to 5B illustrates a graphical view of linear sweep voltammetry data for removal of copper ions from water, in accordance with an embodiment of the present disclosure. FIG. 5A depicts linear sweep voltammetry data for removal of copper ions from water in the concentration range of 10⁻³ to 10⁻⁷ Molar. FIG. 5B depicts EDX data for after the deposition of 10⁻³ Molar copper ions in the pores of anodized porous alumina device.

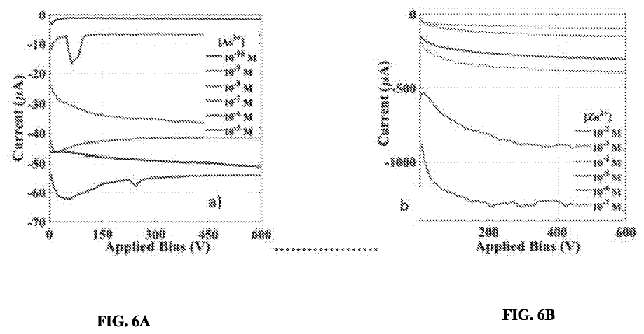

FIG. 6A to 6B illustrates a graphical view of chronoamperometry data for removal of arsenic ions, in accordance with an embodiment of the present disclosure. FIG. 6A depicts chronoamperometry data for removal of arsenic ions for different concentrations of arsenic ions in the range 10⁻¹⁰ to 105 Molar and FIG. 6B depicts chronoamperometry data for removal of zinc ions in the concentration range of 10⁻² to 10⁻⁷ Molar.

TABLE 2
Inductively coupled plasma mass spectrometry (ICP-
MS) data for lead ions after testing the device

| | Initial Concentration Pb²⁺ | Conc. of lead ions after 10 mins of |
|---|---|---|
| S.No. | (ppb) | use of APA (ppb) |
| 1. | 20.7 ppb(10⁻⁷M) | 11.395 |
| 2. | 11.395 | 6.875 |
| 3. | 6.875 | 2.662 |
| 4. | 2.662 | 0.673 |
| 5. | 207.2(10⁻⁶M) | 30.928 |
| 6. | 30.928 | 7.412 |

It will be apparent to those skilled in the art that the device 100 of the disclosure may be provided using some or all of the mentioned features and components without departing from the scope of the present disclosure. While various embodiments of the present disclosure have been illustrated and described herein, it will be clear that the disclosure is not limited to these embodiments only. Numerous modifications, changes, variations, substitutions, and equivalents will be apparent to those skilled in the art, without departing from the spirit and scope of the disclosure, as described in the claims.

### Advantages of the Present Disclosure

The present disclosure provides a device that is excellent in heavy metal removal accuracy and considerably improves the amount of filtration in less time.

The present disclosure provides a device that removes heavy metal ions from water and effluents.

The present disclosure provides a device that reduces the water discard occurred in the reverse osmosis.

The present disclosure provides a compact, low-temperature, cost-effective, and efficient device.

We claim:

1. A device (100) for removal of heavy metal ions from water, the device (100) comprising:
a substrate (102);
a metal layer (10) is deposited on the substrate (102) to form a conducting electrode; and
a thick layer of aluminium (Al) (106) is deposited on the metal layer (104), wherein the aluminum layer (106) is anodized so as to form an anodized porous alumina layer (108) having nanopores, and
wherein the device, upon application of potential, allows the flow of water through the micropores to perform absorption of contaminants using the electrically conducting electrode covered with the anodized porous alumina layer facilitating removal of the contaminants from the water through ion concentration polarization and minimizing wastage of water.

2. The device as claimed in claim 1, wherein the anodized porous alumina layer (108) having the naopores whose degree of porosity and pore size fall within predetermined ranges.

3. The device as claimed in claim 1, wherein the anodized porous alumina layer (108) increases the adsorption of the contaminants by order of magnitude.

4. The device as claimed in claim 1, wherein the contaminants are heavy metal ions selected from a group comprising copper ion (Cu²⁺), Cadmium ion (Cd²⁺), lead ion (Pb²⁺), zinc ion (Zn²⁺), arsenic ions and any combination thereof.

5. The device as claimed in claim 1, wherein the substrate (102) is selected from a group comprising silicon, borosilicate glass, polyethylene terephthalate (PET), polydimethylsiloxane (PDMS), non reactive flexible substrates and any combination thereof.

6. The device as claimed in claim 1, wherein the metal layer is selected from gold, or platinum, with titanium (Ti) or chrome (Cr) as adhesive layer and any combination thereof.

7. The device as claimed in claim 1, wherein the anodization is performed over thermally deposited aluminum layer, wherein electrochemical process is used to analyse the adsorption of ions over the surface of the anodized porous alumina layer (108).

8. The device as claimed in claim 1, wherein the aluminum layer (106) is anodized so as to convert the aluminum layer (106). to aluminum oxide (Al₂O₃).

9. The device as claimed in claim 1, wherein the device (100) is mounted in the water purifier and the water to be filtered is received from the source and adapted to allow the flow of water through the anodized porous alumina layer and reduce contaminants.

10. The method (300) of removal of contaminants from water using a device, the method comprising:
forming (302) a holding substrate;
depositing (304) a metal layer on the substrate to form a conducting electrode;
forming (306) a thick layer of aluminium (Al) on the metal layer; and
anodizing (308) the aluminum layer to form an anodized porous alumina layer having nanopores, wherein the device, upon application of potential, allows the flow of water through the pores to perform absorption of contaminants using the electrically conducting electrode covered with the anodized porous alumina layer facilitating removal of the contaminants from the water through ion concentration polarization and minimizing wastage of water.
